(19) United States
(12) Patent Application Publication
(10) Pub. No.: US 2009/0031281 A1
(43) Pub. Date: Jan. 29, 2009

(54) Method and System for Creating Visual Programs

(75) Inventors: Rui Zhang, Beijing (CN); John R. Hajdukiewicz, Minneapolis, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/829,590

(22) Filed: Jul. 27, 2007

(51) Int. Cl. G06F 9/44

(52) U.S. Cl. 717/105

(57) ABSTRACT

Disclosed herein are a method and system for creating visual programs using a graphical notation. In a preferred embodiment, a visual programming system is provided. The visual programming system comprises (a) a processor; (b) data storage; and (c) program code stored in the data storage and executable by the processor. The program code is executable to implement a graphical notation that can be used to create visual programs displayable on a monitor, wherein the graphical notation comprises objects and connectors that connect the objects to other objects, wherein the objects comprise control flow objects and standard objects, and wherein the control flow objects substantially direct execution of the visual program. The program code is further executable to implement a visual program engine operable to execute visual programs created using the graphical notation, thereby causing the processor to carry out processes as indicated by the visual programs.

### FIELD OF THE INVENTION

The present invention relates to systems and methods for computer programming, and more specifically, visual computer programming.

### BACKGROUND OF THE INVENTION

Computers assist us in almost every facet of our lives. As a result, the ability to design and create computer programs is a powerful tool. The human brain cannot perform calculations at anywhere near the rate of modern computer processors. As a result, computer programs can model and simulate scenarios that cannot be otherwise understood, or would otherwise take much longer to complete.

Unfortunately, the learning curve for programming languages, including powerful languages such as Java and C++, may be prohibitive for those without training in computer science or related fields. Accordingly, programming systems and methods allowing non-programmers to easily develop computer programs, without requiring knowledge of complicated programming languages, are desirable.

### SUMMARY OF THE INVENTION

A visual programming system and method for creating visual programs are disclosed herein. Users, both non-programmers and programmers alike, may use the system to create visual representations of computer programs. More specifically, users may define visual programs including control flow objects and standard objects that in turn, may have various properties, as well as connectors between these objects, using a graphical user interface (GUI). The connectors may include control flow connectors and data flow connectors. The program can then be executed as indicated by the control flow objects and/or control flow connectors.

In one embodiment, a visual programming system for creating visual programs on a graphical display is disclosed. The visual programming system includes (a) a processor, (b) data storage, and (c) program code stored in the data storage and executable by the processor. The program code is executable to implement a graphical notation that can be used to create visual programs that are displayable on a monitor. The graphical notation comprises objects and connectors that connect the objects to other objects. Further, the objects comprise control flow objects and standard objects, wherein the control flow objects substantially direct execution of the visual program. The program code is also executable to implement a visual program engine. The visual program engine may be configured to execute visual programs that are described using a graphical notation disclosed herein, causing the processor to carry out the functionality defined by the visual programs.

The visual program engine may be operable to execute visual programs created using the graphical notation at runtime. Alternatively or additionally, the visual program engine may be operable to generate program code corresponding to the visual programs created using the graphical notation, wherein the program code can be compiled and executed, thereby causing the processor to carry out one or more processes defined by the visual programs. The program code may be generated in one or more programming languages, such as Java and/or C++, for example. When the engine is operable to generate program code in multiple programming languages, the system may provide functionality allowing the user to select an output programming language.

The system may also include program code executable to serialize a visual program created using the graphical notation. Serializing the visual program may result in the creation of a file that can be used by the visual program engine to execute the visual program. For example, a visual program may be serialized by generating an XML file representing the data and/or structure of the visual program. The visual program engine may then use the XML file as a basis for executing the visual program.

In the graphical notation, each connector may include an indication of at least two objects that are connected by the connector. In addition, the connector may indicate a direction in which the connector propagates data between the two objects or may indicate that the connector propagates bi-directionally between the two objects. For example, direction may be defined explicitly, or may be defined implicitly by designating a source and destination object for the connector. Also in the graphical notation, each of the objects may include one or more properties. Each object may have an associated name and/or type. Further, the properties may be of a particular data type. Properties may also be directional, having data flowing into the property, out of the property, or both.

In another embodiment, a method for creating a visual program is disclosed. When created, the visual program is executable to cause a processor to carry out one or more processes. The method comprises (a) creating a plurality of visual objects that are displayed on a graphical interface, wherein the objects comprise standard objects and control flow objects, and wherein the control flow objects substantially define the order in which the objects are executed, (b) creating a plurality of connectors comprising data flow connectors and control flow connectors, wherein the connectors connect the objects, and (c) using the objects and connectors as a basis for executing the visual program, thereby causing a processor to carry out one or more processes. To use the objects and connectors to execute the visual program, the objects and connectors may be serialized into an XML, file, which can then be executed.

In a preferred embodiment, each connector may include a designation of at least one object as a source object and a designation of at least one object as a destination object. In addition, the control flow objects may include a START object and an END object. The connectors may include a connector designating the START object as the source object and a control flow object as the destination object, and a connector designating a control flow object as the source object and the END object as the destination object.

In such an embodiment, the visual program may be executed by (i) creating an object list, a connector stack, and a variable current object, (ii) setting the first control flow object as the current object, (iii) determining which connectors designate the current object as a destination object and adding the connectors designating the current object as a destination object to the connector stack, (iv) from each connector designating the current object as a destination object; adding the source object to the object list, (v) if the object list includes at least one object, determining whether a next object in the list is a standard object or a control flow object and (a) if the next object is a standard object, removing the next object from the object list; setting the current object placeholder to point to the next object; and repeating at least steps (iii)-(vi) or (b) if the next object is a control flow object removing the next object from the object list and repeating at least steps (v)-(vi), (vi) if the object list does not include an object, propagating data for properties of the objects by processing the connectors in the connector stack, (vii) after propagating data to the control object, executing the control flow object, (viii) if the next control flow object is not the END object, repeating steps, setting the next control flow object as the current object and repeating steps (iii)-(ix) with the next control flow object as the current object, and (ix) if the next control flow object is the END object, ending the execution of the visual program.

These as well as other aspects, advantages, and alternatives, will become apparent to those of ordinary skill in the art by reading the following detailed description, with reference where appropriate to the accompanying drawings.

### BRIEF DESCRIPTION OF THE DRAWINGS

Presently preferred embodiments of the invention are described below in conjunction with the appended drawing figures, wherein like reference numerals refer to like elements in the various figures, and wherein:

FIG. 1 is a simplified block diagram depicting an example of a visual program created using an exemplary graphical notation;

FIG. 2 is a flow diagram illustrating a method for creating and executing a visual program created with the preferred graphical notation;

FIG. 3 is a flow diagram illustrating a method for executing a visual program created with the preferred graphical notation; and

FIG. 4 is a table showing states of data structures involved in executing a visual program created with the preferred graphical notation.

### DETAILED DESCRIPTION

A method and system for creating visual programs using a graphical notation is disclosed herein. Among many benefits, the preferred graphical notation may help non-programmers (e.g.,user-interface designer, end-user of a model, marketing personnel, management, etc.) and programmers (e.g., software and hardware designers, architects, etc.) work together to create complex programs in various programming domains. Advantageously, these visual programs can be executed at runtime, or a code generator can translate the visual programs into source code in various programming languages.

The exemplary notation includes objects and connectors. An object can either be a standard object or a control flow object. Both types of objects can include one or more properties. Each property may have various characteristics. For example, properties may have a name, type, value, and/or data-flow direction(s) (e.g., input, output, etc.). Further, properties of an object may include one or more of such characteristics. Connectors may be control flow connectors or data flow connectors. Control flow connectors dictate the sequence in which the functions of a visual program are performed by connecting control flow objects, indicating an order in which the objects making up the visual program should be processed and/or executed. It should be understood that “execution” of a visual program may involve a visual program engine interpreting and processing the visual program. Data flow connectors control data inputs and outputs in a visual program by connecting inputs and outputs of objects to inputs and outputs of other objects.

Preferably, the visual programming system may take the form of a graphical user interface (GUI) that allows a user to create visual programs using a graphical notation. Alternatively, the visual programming system may take the form of a vocal user interface, creating visual representations of objects and connectors in response to voice commands from the user. The visual programming system may take other forms as well.

Objects and connectors may be presented visually in various ways. Preferably, each object is represented by a rectangle, which includes a partition for each property. Flow connectors are represented by lines terminating with an arrow, while data connectors are represented by solid lines. The object type (standard or control flow) may be indicated in various ways. For example, all objects may be represented similarly with control flow objects being identifiable as the destination or target object of a control flow connector. Alternatively or additionally, distinct shapes may be used to visually represent control flow and standard objects. In other alternative embodiments, objects and connectors may be presented in almost any manner, so long as the user can differentiate between standard objects, control flow objects, data connectors, and control flow connectors, and can create a visual program using the presentations of these objects and connectors.

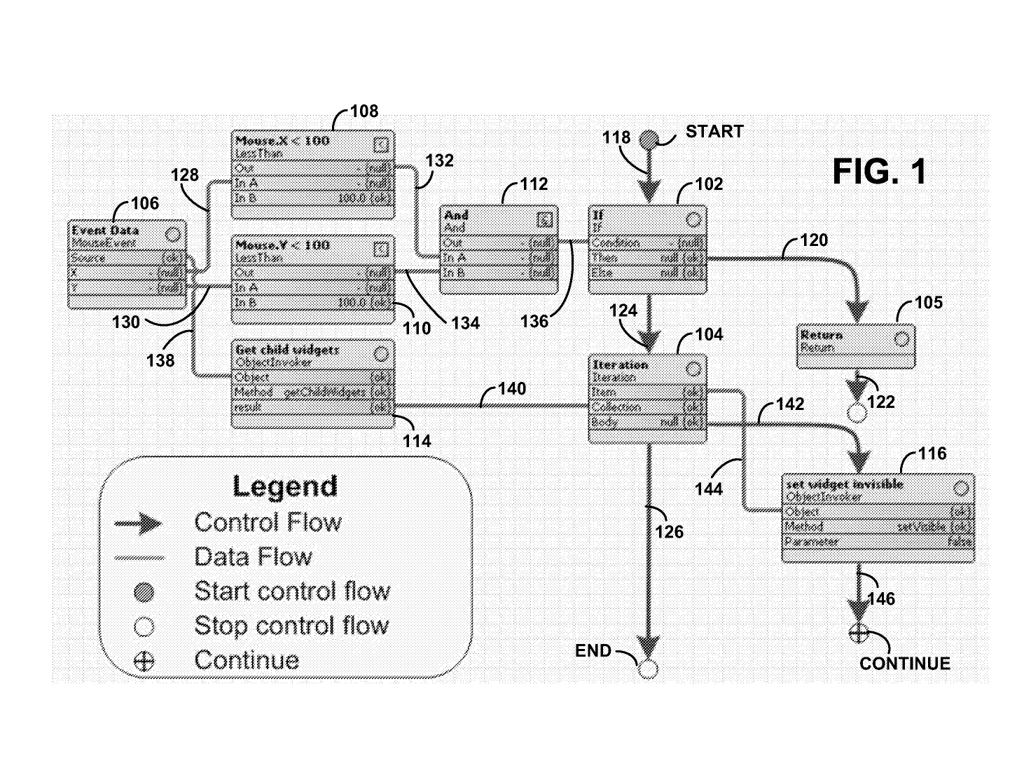

FIG. 1 depicts a visual program 100 created with a graphical notation according to an example. The visual program 100 includes control flow objects 102, 104, 105, and 116, and standard objects 106, 108, 110, 112, and 114. The visual program 100 also includes control flow connectors 118-126 and data flow connectors 128-146. Each control flow object is executed by connecting and propagating data flow connectors to supply values for the properties of the control flow objects. For example, the values may be supplied from standard objects via data flow connectors. Once a control flow object has served its purpose, control is transferred to the next control flow object via a control flow connector.

The program 100 initiates at the START object, and follows the first control flow connector 118 to “If” control object 102. For simplicity, this control flow object 102 is named “If” and is of the type “If.” In a visual programming environment, an object may by default take its type as a name or may default to a name determined by another naming convention. In either case, the user may change the name to be as they desire. For example, the control flow object 116 is of the type “WidgetInvoker,” but in this example the programmer set the name to be “Set Widget Invisible.” A visual programming environment may employ various techniques now known or yet to be developed for a name change. As one example, the user may accomplish a name change by moving a mouse pointer over the name, clicking a mouse button (at which point the name may be highlighted or distinguished in some fashion), and typing the desired name. It should also be understood that the user may perform this and other such visual programming tasks using a GUI or other types of programming interfaces.

The “If” control flow object 102 functions to determine whether or not a “Condition” is met, and accordingly takes one action if the condition is met (i.e., follows control flow connector 120 to control flow object 105), or takes another action if the condition is not met (i.e., follows control flow connector 124 to control flow object 104). The “Condition” is a property of a control flow object of the type “If.” The “Condition” property of “If” control flow object 102 receives data via data flow connector 136, which transmits the output from the “Out” property of standard object 112 to the input of the “Condition” property.

Standard object 112 is of the type “And” (and by default, named “And” as well). The “And” standard object receives two inputs, “In A” from data flow connector 132 and “In B” from data flow connector 134. If both “In A” and “In B” have the value “True” (or an equivalent logical expression), the value of the Out property is set to “True,” but otherwise is set to “False.” The value for “In A” is received from standard object 108 and the value for “In B” is received from standard object 110.

Standard objects 108, 110 are of the type “LessThan” and in this case, the user has elected to give these LessThan objects descriptive names (“Mouse.X <100” and “Mouse.Y <100,” respectively—these objects 108, 110 are also referred to herein as “Mouse.X” 108 and “Mouse.Y” 110, respectively). A “LessThan” object uses two inputs. In this case, Mouse.X 108 receives input for the value of “In A” via data flow connector 128, while Mouse.Y 110 receives input for the value “In A” from data flow connector 130. These data flow connectors 128, 130 receive data from the output of property “X” and property “Y”, both of standard object 106.

A value for a property may exist independently of inputs to the property. For example, the user defined the property “In B” to be 100 in both Mouse.X 108 and Mouse.Y 110. To do so, the user may have simply typed in or hardcoded this value (as opposed to using a connector to propagate data to “In B” from another object). Accordingly, for “In B”, the property status is set to “ok”, indicating that the value for the property is determined and does not require further processing. Likewise, a property status of “null,” which indicates a value has yet to be determined for the property in question, may be set to “ok” once the value is determined from the appropriate inputs. It should be understood that the property status can be reset or adjusted by the user, or may be automatically adjusted based on the design of the program. Further, once a control flow object is fully processed, the property status for all properties that initially were set to “null,” may be reset to “null” if they have changed in the processing of a control flow object.

Standard object 106 (also referred to herein as “Event Data” 106) is of the “MouseEvent” type and has been given the descriptive name “Event Data.” A MouseEvent object has three properties: “Source”, “X”, and “Y.” The “Source” property indicates a location on a display on which a mouse pointer may be presented and controlled by a user. The location may be defined by two-dimensional coordinates indicating the location of a mouse pointer on a visual display. As such, property X and property Y of Event Data 106 indicate the distance of the mouse pointer from the Source on an x-axis and y-axis, respectively. Various techniques for binding code to a visually displayed object may be used to bind Event Data 106 to coordinates on a visual display and appropriately feed data to Event Data 106.

For example, a rectangular visual display may have a resolution of 800 by 600 pixels, and coordinates may be defined in terms of the pixels with (0, 0) being the lower left corner of the visual display. Therefore, a user may bind a location identified by coordinates (400, 300) to Event Data 106, which sets (400, 300) as the Source. When the Event Data object is executed, X and Y indicate the distance between the mouse pointer and the Source (e.g., the number of pixels horizontally and vertically from the Source coordinates). More specifically, X may be defined as X=ABS(horizontal coordinate of mouse pointer—400) and Y may be defined as Y=ABS(vertical coordinate of mouse pointer—300), where “ABS” is the absolute value operator. Note that any display shape or coordinate system may be used, and therefore the rectangular display of this example should not be construed as limiting.

In one aspect, using control flow objects allows for execution of code at runtime. The control flow objects can be processed one at a time, following the path of control flow, as indicated by control flow objects and connectors. Runtime execution may be accomplished in various ways. For example, a visual programming environment may include or have access to program code that is executable to serialize a visual program, creating a text-based file that captures the visual program. The text-based file is preferably an XML, file, although other formats may be utilized. As an alternative, program code (e.g., Java or C++ code, for instance) may be generated from the visual program. This flexibility can help non-programmers work together with programmers to develop program code in various programming languages, without requiring knowledge of the programming languages. For example, a non-programmer could create a visual program and generate corresponding Java code. The generated code can be directly used by a skilled Java programmer to create a more complex program. Thus, collaboration between programmers and non-programmers may be enhanced.

For example, a user may bind visual program 100 so that the program executes on the occurrence of a certain event or certain events, such as the movement of a mouse. Accordingly, when a mouse movement occurs, the program begins execution at the START of control flow and proceeds to the first control flow object, which is “If” control flow object 102. As the property status of “Condition” is “null,” a value for this property must be determined. The value of “Condition” ultimately derives from Event Data 106, and therefore processing begins with Event Data 106, which provides inputs to Mouse.X 108 and Mouse.Y 110. Mouse.X and Mouse.Y then pass data to “And” object 112, which then outputs a value to the “Condition” property.

Returning to the previously described example, where the Source is set as the coordinates (400, 300), the user might subsequently position the mouse at a location on the visual display identified by coordinates (427, 281). As the X and Y properties have a status of null, values for these properties may accordingly be determined. The X and Y properties may be bound to the location of the mouse, and therefore be set as X=ABS(427−400)=27 and Y=ABS(281−300)=19. The property status for X and Y is then set to “ok” indicating these values are determined and can be propagated via data flow connectors 128, 130 to Mouse.X 108 and Mouse.Y 110, respectively.

Mouse.X 108 and Mouse.Y 110 receive the outputs from X and Y into their “In A” properties. According to the “LessThan” type, “In A” is set as 27 for Mouse.X 108 and 19 for Mouse.Y 110. As the value of “In A” (27) is less than the value of “In B” (100), the “Out” property is set as “True” for Mouse.X 108. Similarly for Mouse.Y 110, the “Out” property is set as “True” because the value of “In A” (19) is less than the value of “In B” (100). “And” object 112 then receives the output from the “Out” property of Mouse.X 108 and the “Out” property of Mouse.Y 110 and accordingly sets the value of “In A” to be “TRUE” and the value of “In B” to be “TRUE.” Since both “In A” and “In B” are true, “And” object 112 sets the value of its “Out” property as “TRUE.” The value of the “Out” property (“TRUE”) is then sent via data flow connector 136 to the “Condition” property of control flow object 102.

Once a value for the “Condition” property of “If” object 102 is determined, the control flow object can execute. In this case, the “Condition” is “TRUE,” and accordingly, the control flow follows control flow connector 120 to control flow object 105. Control flow object 105 is a “Return” object, which functions to end the program without performing further visual operations. In particular, “Return” object 105 simply passes control along control flow connector 122 to the END control flow object. In the program depicted by FIG. 1, the result of this path is hiding a mouse pointer when the pointer is located beyond 100 pixels, horizontally or vertically, from the source location.

In the above example, control flow never passed to control flow object 104, and therefore, this object was not executed. If, however, the mouse moved to a different location that resulted in the “Condition” property of “If” object 102 being set as “false,” control flow would pass from “If” object 102 to control flow object 104 (referred to herein as “Iteration” object 104), via control flow connector 124. In particular, any coordinates more than 100 pixels away from the Source, in either direction, result in “Condition” being false.

If the “Condition” property of “If” object 102 is false, after “If” object 102 has executed, control flow passes to Iteration object 104 via control flow connector 124. An “Iteration” object holds a collection of items (i.e., the “Collection” property of the Iteration object) and may be responsible for both data flow and control flow of the visual program. The Collection property may be empty or it may contain one or more items. If the collection is not empty, the “Item” property of the Iteration object may be linked to a current item from the collection. In this case, the “Collection” property of Iteration object 104 receives data via data flow connector 140, Get Child Widgets object 114, data flow connector 138, and ultimately from Event Data object 106.

Standard object 114 is of the type “WidgetInvoker” and has been named “Get Child Widgets” by the user (also referred to herein as Get Child Widgets object 116). A WidgetInvoker object receives a widget as input, stores the widget in the “Widget” property, runs a method (e.g., a function or algorithm) designated by the “Method” property, and outputs a result (i.e., the “Result” property). For example, via data flow connector 138, Get Child Widgets object 114 may receive a widget from the “Source” property of Event Data 106, and store the widget in the “Widget” property. The input received via data flow connector 138 may then be used as input for the getChildWidgets method. The output of the getChildWidgets method (child widget(s) from the Source property of Event Data 106, for instance) may then be passed via data flow connector 140, to the Collection property of Iteration object 104.

The data received from data flow connector 140 may be stored by the Collection property of iteration object 104. For example, the Collection may store one or more widgets, such as a child widget or widgets associated with an object originating from the Source property of Event Data object 106. Initially, the Item property of Iteration object 104 may store a first widget stored by the Collection property. It should be understood that a collection does not require an order—the collection may have a predetermined order or may have no order at all. Further, the Collection may be an empty set or null, in which case the Item property may also be null. If the Item property is null (meaning the Collection is empty), control flow may follow control flow connector 126 to the END object.

The Body property of iteration object 104 acts as a pointer which specifies a control flow object. When the collection is not empty, the body property may indicate a control flow object to which control flow should be passed. In this case, because the Collection includes data received from Get Child Widgets 114, control flow will follow control flow connector 142 to control flow object 116 (which is of the WidgetInvoker type, named “Set Widget Invisible” by the user, and also referred to herein as Set Widget Invisible object 116). The Set Widget Invisible object 116 illustrates that in some embodiments, objects of a given type may be used as data flow and/or control flow objects. In FIG. 1, Get Child Widgets object 114 and Set Widget Invisible object 116 are both WidgetInvoker objects. Set Widget Invisible object 116 is the target object of control flow connector 142 and thus functions as a control flow object, while Get Child Widgets object 114 is a standard object.

Set Widget Invisible 116 receives, via data flow connector 144, data from the Item property of Iteration 104. This data may be stored by the Object property of Set Widget Invisible object 116. The setVisible method, designated by the method property of Set Widget Invisible object 116, may take data from the widget property as input. In this example, unlike Get Child Widgets 114, Set Widget Invisible 116 does not output data because the user has set the Parameter property to be false. If the method setVisible returns a value after execution, the Parameter property of an ObjectInvoker object may also be set to be true and accordingly, the source object upon which setVisible operates may be returned. Control flow then follows control flow connector 146 to the CONTINUE object. The CONTINUE object may pass control flow back to the START object. Therefore, the program may again begin executing from the START object, control flow may be passed to iteration object 104 if the value of If object 102 has not changed, etc.

Alternatively, the user may specify that the CONTINUE object passes control flow back to Iteration object 104, or any other control flow object. If control flow is next passed to Iteration object 104, and if items remain in the Collection property (that have not been passed via data flow connector 144 to Set Widget Invisible object 116), control flow again passes via control flow connector 142 to Set Widget Invisible object 116 and back to the START object, or any other object specified by the user, via the CONTINUE object, until the setVisible method has been run for each Item in the Collection.

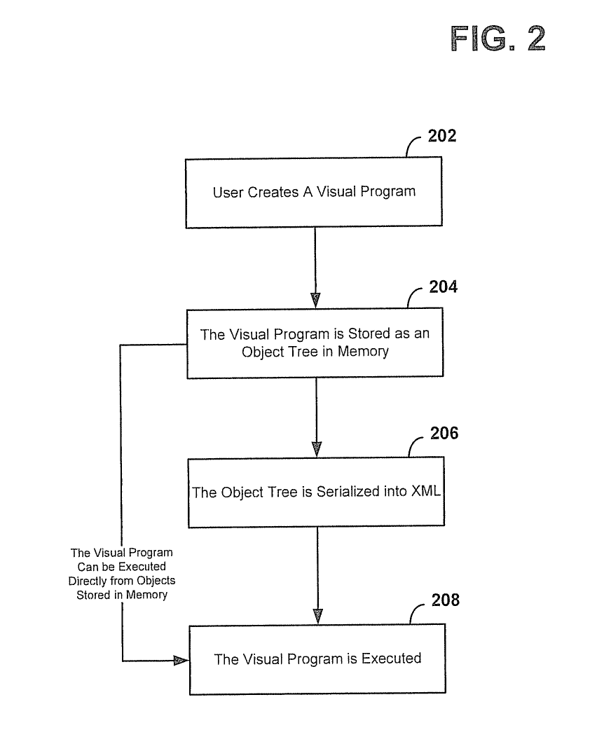

FIG. 2 shows a process for creating and executing a visual program. First, a user creates a visual program, as shown by block 202. Second, the visual program may be stored in memory as an object tree, as shown by block 204. The visual program may be stored in memory when a user saves the visual program or at other appropriate times (such as when a new object or connector is created, for instance). Third, the object tree may be serialized into binary code or a human-readable text format such as XML (Extensible Markup Language), as shown in block 206. Alternatively, a visual program may be executed directly from the object tree stored in memory. After serializing the visual program, the visual program may be executed, as shown by block 208.

It should be understood that the visual program may be executed “on-the-fly.” In other words, the visual program may be executed as it is created. Alternatively, a visual program engine may generate source code in one or more programming languages (e.g., Java, C++, etc.). The source code may be compiled so that the visual program can be executed at a later point in time.

The visual program may be created using a graphical notation to the notation illustrated in FIG. 1. The visual program may include data flow objects and control flow objects as well as data flow connectors and control flow connectors.

Once a visual program is created by a user, the program may be stored as an object tree in memory, as shown by block 204. A visual program may be stored as an object tree in memory for both editing and execution. An object tree may consist of a root node, from which child nodes (children) may be linked. Each node may have zero or more children with the result being that a tree may have any number of levels. Each node may store information about an object (standard or control flow) from the visual program. The nodes may also store information about the connectors (data or control flow) that are connected to each object, the visual location of objects and their connectors on a two-dimensional grid of a graphical display, and/or any other information about the visual program.

An object tree may then be serialized into binary code or a human-readable text format such as XML, (Extensible Markup Language), as shown by block 206. Methods for serializing data from an object tree are well known in the art. For example, DOM (Document Object Model) or SAX (Simple API for XML,) are commonly used as APIs (application programming interface) for accessing/processing XML elements. As another example, ORB (Object-relational bridge) technologies are also very mature in the industry, and may be used to serialize a visual program stored as an object tree. Any of these technologies may be used to store the visual program data in a file or database, or to build up object-based data structures in memory directly from the data in relational databases or files.

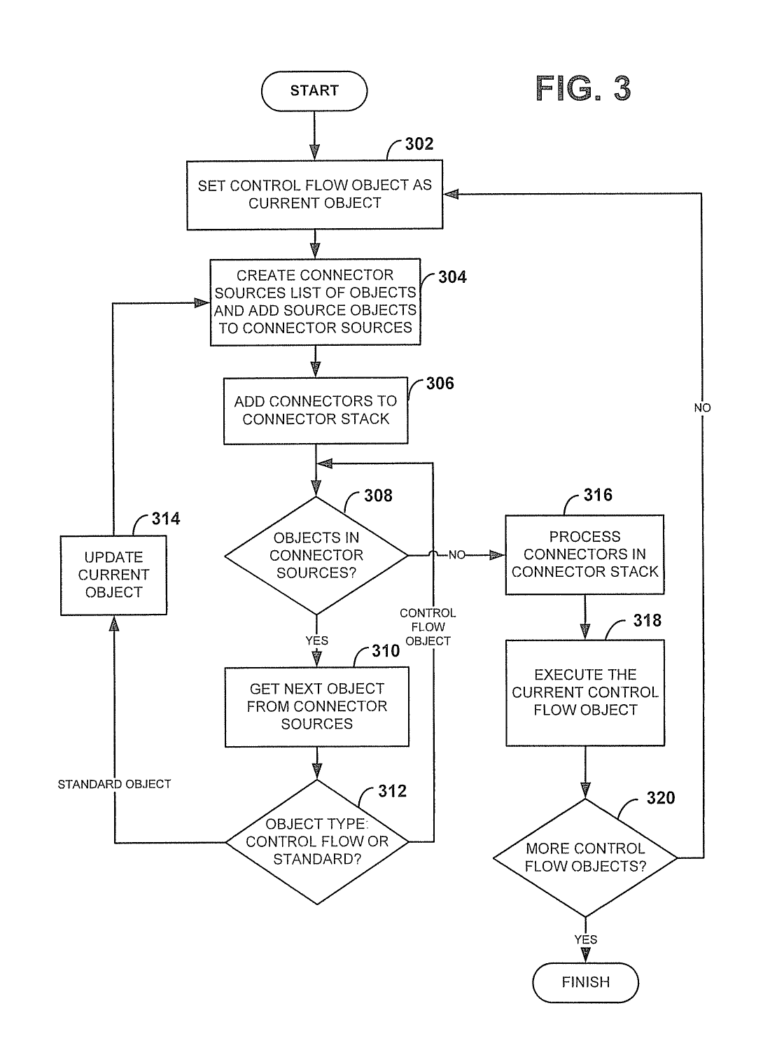

The visual program may then be executed as shown by block 208. The method shown in FIG. 3 may be used to execute the visual program. Preferably, serialized or non-serialized programs may be executed by a visual programming engine.

FIG. 3 shows a method for executing a visual program with standard and control flow objects. This method may be performed by a visual program engine. A visual programming system or environment may include or have access to such a visual program engine in order to execute a visual program at runtime and/or generate program code from the visual program. The method is described by way of example with reference to a visual program engine. This should not be construed as limiting the scope of the invention, as other means may be employed to execute the visual program.

The control flow objects may be executed in a predetermined order, or an order determined wholly or partially as the control flow objects are executed. For example, the order of execution may vary depending on the properties of an “If” control flow object, and proceed in a first order in one case, and a second order in a second case. Generally, execution will begin from a START control flow object, and terminate at an END control flow object, although variations are possible.

To execute a control flow object, the visual program engine sets a “current object” to point to the first control flow object (i.e., the control flow object targeted by the control flow connector from the visual program START), as shown by block 302. The current object is a pointer that is used to iterate through the standard objects associated with a particular control flow object. Then, as shown by block 304, the engine determines the connectors having the current object as a destination object (i.e., connectors feeding into an input of a property of the current object) and creates a “Connector Sources” list. The engine then adds the source objects for these connectors to the Connector Sources list. In addition, each of these connectors is added to a “Connector Stack” as shown by block 306. It should be understood that while blocks 304 and 306 are shown separately, these blocks may be related and thus performed concurrently or separately.

After updating Connector Sources and the Connector Stack, the engine determines whether any items remain for consideration in Connector Sources, as shown by decision block 308. If source objects remain in Connector Sources, the engine accesses the source object from the next connector in Connector Sources, as shown by block 310. The engine then determines whether or not the next source object in Connector Sources is a control flow object or a standard object, as shown by decision block 312. If the source object is a control flow object, the engine loops back to decision block 308 to consider the next source object in Connector Sources (if any source objects remain on the list). The source objects and connectors are not added to Connector Source and/or the Connector Stack unless the control flow object is the current object, as shown by block 302.

If the source object is a standard object, the source object is set as the current object (e.g., by changing the current object pointer to reference the source object), as shown by block 314. The method then loops back to block 304, and repeats blocks 304-308 (and 310-314, depending on the result of decision block 308) with the former source object as the new current object. Accordingly, the Connector Sources list is updated to include connectors having the new current object as a destination object. Further, connectors designating the new current object are added to the Connector Stack (in addition to whatever connectors have previously been added to the Connector Stack).

The engine repeats blocks 304-306 until no objects remain in Connector Sources. In particular, when decision block 308 determines that all connectors in Connector Sources have been considered, the engine proceeds to process all connectors in the Connector Stack, as shown by block 316. By recursively iterating through the visual program in blocks 304-314, the engine may effectively populate the Connector Stack in the order the connectors should be processed. In particular, connectors are added to the top of the Connector Stack, and pulled from the top as well. Therefore, the last connector added to the Connector Stack will be the first processed by the engine (i.e., last in, first out).

Once the connector Stack has been populated, as shown by blocks 304-314, each connector may be pulled from the Connector Stack so that processing may be applied to each connector, as shown by block 316. When a connector is processed, the source object and destination object of the connector may be identified. In addition, a “source property” of the source object, and a “destination property” of the destination object may be identified for the connector. The source object may be executed in the value of the source property may then be propagated to the destination property of the connector. The visual program engine continues to process connectors until all connectors in the Connector Stack have been processed.

Preferably, the Connector Stack is ordered so that the value of the source property is determined and available for propagation to the destination property. In particular, the connector or connectors on top of the stack (i.e., connectors that are first in line for processing) generally have a source property that is determined independently (i.e., these objects are not the target of any connector). Data from these source objects may be propagated to destination objects, which are next in the stack, and accordingly may be processed next. Preferably, the order of the Connector Stack wherein source properties are processed before their respective destination properties results because destination objects are placed in the stack just prior to their related source objects and the stack uses a last in/first out (LIFO) order of operation.

After data has been propagated through the connectors in the Connector Stack, to the control flow object to be executed (i.e., the control flow object that was originally set as the current object in block 302), the control flow object is executed, as shown by block 318. Execution of a control flow object may have various results. For example, any methods designated by the properties of the control flow object may be executed. Further, executing a control flow object may cause control to be passed, via one of multiple control flow connectors, to the next control flow object, or possibly to an END object.

After executing the control flow object, a determination may be made as to whether more control flow objects should be executed, as shown by block 320. If all control flow objects in the visual program have been executed, execution of the program is finished. However, if one or more control flow objects still needs to be executed, a next control flow object (as indicated by a control flow connector) is set as the current object in block 302. The processes shown in blocks 302-320 may then be repeated until all control flow objects have been executed.

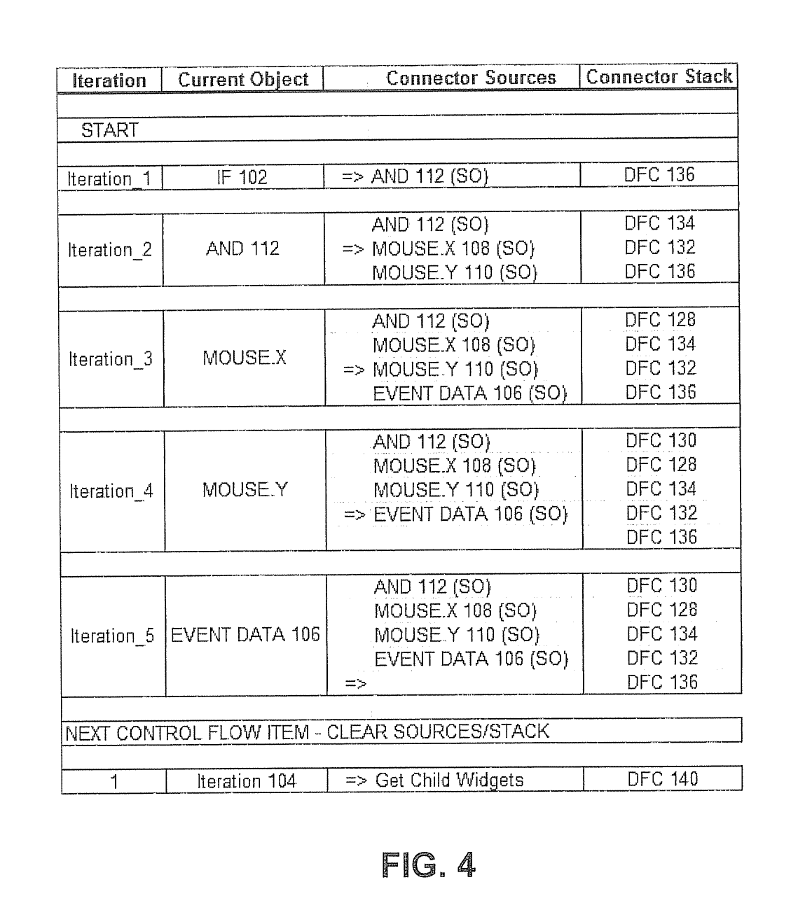

FIG. 4 is a chart showing data states as the visual program engine executes the visual program shown in FIG. 1, using a method such as that represented in FIG. 3. Preferably, the visual program is serialized into a text-based file format, such as an XML file, before the engine executes the program. Therefore, the engine executes the program using the XML, file, rather than the visual program itself. However, a visual program engine may alternatively or additionally operate to execute a visual program using the program directly (e.g., by interacting directly with a visual programming environment).

In FIG. 4, the visual program engine begins processing the visual program 100 at the START object, following the control flow connector 118 to the first control flow object, which is “If” object 102. The engine then proceeds to Iteration_1, as shown in FIG. 4. In Iteration_1, “If” object 102 is set as the current object. Since “If” 102 is the destination object of data flow connector (DFC) 136, “And” 112, which is the source object of DFC 136, is added to Connector Sources. In addition, DFC 136 is added to the Connector Stack.

A pointer (“=>”) indicates the next object on the Connector Sources list (i.e., the object following the currently considered object, or in the case of the first object, in this case “If” 102, the next object is simply the first object of Connector Sources). After updating Connector Sources and Connector Stack, the engine checks to see if the next object is a control flow object. If the next object is a control flow object, the engine moves on to the next object or if no further objects are on the Connector Sources, list, proceeds to process the connectors. In this case, the next object is a standard object 112 (referred to herein as the “And” object 112), so the engine sets And object 112 as the current object.

In Iteration_2, the engine then determines that the current object, “And” 112, is the destination object of DFC 132 and DFC 134. Therefore, the engine (1) adds the source objects for DFC 132 and DFC 134 (MOUSE.X 108 and MOUSE.Y 110, respectively) to Connector Sources, (2) adds DFC 132 and DFC 134 to the Connector Stack, and (3) updates the pointer to point to MOUSE.X 108. Since MOUSE.X is a standard object, the engine then sets MOUSE.X to be the current object.

In Iteration_3, the engine determines that the current object, MOUSE.X 108, is the destination object of DFC 128. Therefore, the engine (1) adds the source object for DFC 128 (EVENT DATA 106) to Connector Sources, (2) adds DFC 128 to the Connector Stack, and (3) updates the pointer to point to the next object of Connector Sources, MOUSE.Y 110. Since MOUSE.Y 110 is a standard object, the engine then sets MOUSE.Y to be the current object.

In Iteration_4, the engine determines that the current object, MOUSE.Y 110, is the destination object of DFC 126. However, the source object of DFC 126, which is EVENT DATA 106, has already been added to connector sources. Therefore, the engine does not add EVENT DATA 106 to Connector Sources, but does add DFC 126 to the Connector Stack and updates the pointer to point to the next object of Connector Sources, EVENT DATA 106. Since EVENT DATA 106 is a standard object, the engine then sets EVENT DATA 106 to be the current object.

In Iteration_5, the engine determines that the current object, EVENT DATA 106, is not the destination object of any connectors. Therefore, the engine proceeds to determine whether Connector Sources has more objects for consideration. In this case, the pointer to next object is “null” or “empty” and therefore the engine proceeds to process the connectors.

“Iteration” object 104 is then set as the current object. Since Iteration 104 is the destination object of data flow connector (DFC) 140, “Get Child Widgets” 114, which is the source object of DFC 140, is added to Connector Sources. In addition, DFC 140 is added to the Connector Stack.

After updating Connector Sources and Connector Stack, the engine checks to see if the next object is a control flow object. In this case, the next object is a standard object “Get Child Widgets” 114, so the engine sets “Get Child Widgets” 114 as the current object.

The engine then determines that the current object, “Get Child Widgets” 114, is the destination of DFC 138. Therefore, the engine (1) adds the source object for DFC 138 (Event Data 106) to Connector Sources, (2) adds DFC 138 to the Connector Stack, and (3) updates the pointer to point to Event Data 106. Since Event Data 106 is a standard object, the engine then sets Event Data 106 to be the current object.

The engine then determines that the current object, EVENT DATA 106, is not the destination object of any connectors. Therefore, the engine proceeds to determine whether Connector Sources has more objects for consideration. In this case, the pointer to next object is “null” or “empty” and therefore the engine proceeds to process the connectors.

If “Collection” in “Iteration” object 104 is empty, control will then flow, via control flow connector 126, to END and the program will end. If Collection in Iteration object 104 is not empty, control will flow to “Set Widget Invisible” object 116 via control flow connector 142. In this case, “Collection” is not empty; it contains the data that it has just received from “Get Child Widgets.”

Control then flows to “Set Widget Invisible” 116 via control flow connector 142, and “Set Widget Invisible” 116 is set as the current object. Since “Set Widget Invisible” 116 is the destination object of DFC 144, “Iteration” 104, which is the source object of DFC 144, is added to Connector Sources. In addition, DFC 144 is added to the Connector Stack. “Iteration” 104 does not become the current object because it is a control flow object (See FIG. 2, block 212). Set widget invisible 116 remains the current object and Item propagates from the “Item” slot in “Iteration” 104 to “Object” in “Set Widget Invisible” 116 and “Set Widget Invisible” 116 executes. Control then flows to the continue node at the end of control flow connector 146 and the program starts over again.

Example embodiments of the present invention have been described above. Those skilled in the art will understand, however, that changes and modifications may be made to these embodiments without departing from the true scope and spirit of the invention, which is defined by the claims.

We claim:

1. A visual programming system for creating visual programs that are displayable on a monitor, the system comprising:
a processor;
data storage; and
program code stored in the data storage and executable by the processor to:
implement a graphical notation that can be used to create visual programs displayable on a monitor, wherein the graphical notation comprises objects and connectors that connect the objects to other objects, wherein the objects comprise control flow objects and standard objects, and wherein the control flow objects substantially direct execution of the visual program; and
implement a visual program engine operable to execute visual programs created using the graphical notation, thereby causing the processor to carry out processes as indicated by the visual programs.

2. The visual programming system of claim 1, wherein the visual program engine is operable to execute visual programs created using the graphical notation at runtime.

3. The visual programming system of claim 1, wherein the visual program engine is further operable to generate program code corresponding to the visual programs created using the graphical notation, wherein the program code can be compiled and executed, thereby causing the processor to carry out one or more processes defined by the visual programs.

4. The visual programming system of claim 1, further comprising:
program code stored in the data storage and executable by the processor to serialize a visual program created using the graphical notation, wherein serializing the visual program creates a file that can be used by the visual program engine to execute the visual program.

5. The visual programming system of claim 1, further comprising program code stored in the data storage and executable by the processor to:
serialize the visual program by generating an XML, file that represents the visual program; and
execute the visual program at runtime by interpreting the XML, file.

6. The visual programming system of claim 1, wherein the connectors comprise control flow connectors and data flow connectors.

7. The visual programming system of claim 1, wherein each connector comprises an indication of at least two objects connected by the connector.

8. The visual programming system of claim 7, wherein at least one connector further comprises an indicator of a direction in which data propagates between the two objects or an indicator that the connector propagates data bi-directionally between the two objects.

9. The visual programming system of claim 1, wherein each of the objects comprises one or more properties.

10. The visual programming system of claim 9, wherein at least one of the properties comprises a data type.

11. The visual programming system of claim 10, wherein the at least one property further comprises a value that is in the format of the data type.

12. The visual programming system of claim 11, wherein at least one of the properties comprises a data flow direction indicating whether the property receives data, sends data, or receives and sends data.

13. A visual programming system for creating visual programs that are displayable on a monitor, the system comprising:
a processor;
data storage; and
program code stored in the data storage and executable by the processor to:
implement a graphical notation that can be used to create visual programs displayable on a monitor, wherein the graphical notation comprises standard objects, control flow objects, and connectors that connect standard objects or control flow objects to other standard objects or control flow objects, and wherein the control flow objects substantially direct execution of the visual program; and
implement a visual program engine operable to generate program code corresponding to the visual programs created using the graphical notation, wherein the program code can be compiled and executed, thereby causing the processor to carry out one or more processes defined by the visual programs.

14. The visual programming system of claim 13, wherein the program code is generated in one or more programming languages.

15. The visual programming system of claim 14, further comprising program code stored in the data storage and executable by the processor to allow a user of the visual programming system to select the programming language in which the program code is generated.

16. A method for creating a visual program that is executable to cause a processor to carry out one or more processes, the method comprising:
creating a plurality of visual objects that are displayed on a graphical interface, wherein the objects comprise standard objects and control flow objects, and wherein the control flow objects substantially define the order in which the objects are executed;
creating a plurality of connectors comprising data flow connectors and control flow connectors, wherein the connectors connect the objects; and
using the objects and connectors as a basis for executing the visual program, thereby causing a processor to carry out one or more processes.

17. The method of claim 16, wherein using the objects and connectors as a basis for executing the visual program comprises serializing the objects and connectors into an XML file, wherein the XML file is used to execute the visual program.

18. The method of claim 16 wherein each connector comprises:
a designation of at least one of the objects as a source object; and
a designation of at least one of the objects as a destination object.

19. The method of claim 18 wherein the control flow objects further comprise a START object and an END object, and wherein the connectors further comprise:
a first connector designating the START object as the source object and a first control flow object as the destination object; and
a second connector designating another control flow object as the source object and the END object as the destination object.

20. The method of claim 19, wherein using the objects and connectors as a basis for executing the visual program comprises:
(i) creating an object list, a connector stack, and a variable current object;
(ii) setting the first control flow object as the current object;
(iii) determining which connectors designate the current object as a destination object and adding the connectors designating the current object as a destination object to the connector stack;
(iv) from each connector designating the current object as a destination object; adding the other connected object to the object list;
(v) if the object list includes at least one object, determining whether a next object in the list is a standard object or a control flow object and:
(a) if the next object is a standard object, removing the next object from the object list; setting the current object placeholder to point to the next object; and repeating at least steps (iii)-(vi); and
(b) if the next object is a control flow object removing the next object from the object list and repeating at least steps (v)-(vi);
(vi) if the object list does not include an object, propagating data for properties of the objects by processing the connectors in the connector stack;
(vii) after propagating data to the control object, executing the control flow object;
(viii) if the next control flow object is not the END object, repeating steps, setting the next control flow object as the current object and repeating steps (iii)-(ix) with the next control flow object as the current object; and
(ix) if the next control flow object is the END object, ending the execution of the visual program.
